(19) United States
(12) Patent Application Publication
(10) Pub. No.: US 2003/0014836 A1
(43) Pub. Date: Jan. 23, 2003

(54) Tool holder

(76) Inventors: Martin Kocher, Solothurn (CH); Daniel Grolimund, Zuchwil (CH)

Correspondence Address: Striker Striker & Stenby, 103 East Neck Road, Huntington, NY, 11743, US

(21) Appl. No.: 10/169,890

(22) PCT Filed: Sep. 18, 2001
(86) PCT No.: PCT/EP01/10769

(30) Foreign Application Priority Data
Nov. 15, 2000 (DE) 200 19 375.9

(51) Int. Cl. E05B 1/00

(52) U.S. Cl. 16/110.1

(57) ABSTRACT

The invention is based on a tool holder, having a base body (10) which is formed of at least one plate (22, 24, 26) and which has at least one releasable fastening means (12, 14, 16) for securing a tool (18).

It is proposed that the fastening means (12, 14, 16) is formed by a detent means, which is movable without tools out of its detent position into a position uncovering the tool (18).

### PRIOR ART

The invention is based on a tool holder as generically defined by the preamble to claim 1.

Tool holders embodied as manual scrapers are known that have a base body with two sheet-metal shells. The sheet-metal shells are connected via a screw connection. If the screw connection is undone by a tool, such as a screw driver, then a scraper blade can be introduced between the sheet-metal shells and fastened in place between the sheet-metal shells by means of the screw connection.

### ADVANTAGES OF THE INVENTION

The invention is based on a tool holder, having a base body which is formed of at least one plate and which has at least one releasable fastening means for securing a tool.

It is proposed that the fastening means is formed by a detent means, which is movable without tools out of its detent position into a position uncovering the tool. An especially convenient tool holder that in particular has a plurality of sheet-metal plates joined together and extending in the machining direction can be achieved that is especially stable and is advantageously suitable for machine use. In principle, however, the embodiment of the invention is advantageously applicable to hand-guided tool holders as well. The embodiment of the invention is especially well suited to securing scraper blades, which are driven translationally back and forth, but it is fundamentally also conceivable for other tools appearing useful to one skilled in the art to be secured in the tool holder of the invention, examples being filing tools, grinding tools, with and without additional holders, and so forth. Instead of sheet-metal plates, plates of some other material, such as fiberglass, teflon, etc., are fundamentally also conceivable.

The sheet-metal plates can be stamped out economically or advantageously cut out using a laser cutting method, making it possible to avoid additional tool costs for special production tools, such as stamping tools. If the sheet-metal plates are nondetachably joined together, then individual components that could be lost are advantageously avoided.

If the base body is formed of three sheet-metal plates, specifically a top plate, middle plate and bottom plate, then a receiving region for the tool can be achieved between the bottom plate and the top plate in a structurally simple way, and in particular, the tool can be braced by positive engagement on the middle plate counter to the machining direction. Via the middle plate disposed between the bottom plate and the top plate, major forces can be transmitted to the tool. Instead of three sheet-metal plates, however, only a single sheet-metal plate, or two sheet-metal plates, or more than three sheet-metal plates are equally conceivable.

Moreover, individual sheet-metal plates can advantageously be utilized to form an overall stable body yet nevertheless to create individual, elastically deflectable regions for detent means that can be released without tools, specifically by disposing at least one fastening means or detent means on a partial region of a sheet-metal plate, preferably the top plate or the bottom plate, which region is deflectable elastically by hand without tools perpendicular to the sheet-metal plate in order to release the fastening means. To prevent the partial region from being capable of being deflected by a force on the tool during operation with the tool holder, the partial region is advantageously laterally exposed by recesses and bounded laterally by cheeks that are solidly joined to an adjacent sheet-metal plate. Via the cheeks, the tool can be braced perpendicular to the sheet-metal plate, without deflecting or loading the partial region.

To enable convenient deflection of the sheet-metal plate with the fastening means independently of the other sheet-metal plates, at least one sheet-metal plate is advantageously embodied with a recess, through which the partial region can be loaded to release the fastening means. If the recess is at least finger-sized, then the partial region can be loaded efficiently through it, for instance using a thumb. A load on other components or other sheet-metal plates with an attendant increased expenditure of force can be averted.

If at least one fastening means is formed onto a sheet-metal plate, then additional components, assembly effort, and expense can be saved. In principle, however, it would also be conceivable for a fastening means to be formed of an additional component secured to a sheet-metal plate.

It is also proposed that at least one fastening means be formed by a tab pointing counter to the machining direction, thus achieving an especially secure hold in the machining direction and making it possible to reliably prevent unintentional release. A kind of barb action can be attained.

The sheet-metal plates can be joined by means of various nonpositive, positive and/or materially engaged connections that appear useful to one skilled in the art, such as a rivet connection, a screw connection, a positive connection produced by a shaping operation, an adhesive bond, and so forth. However, the sheet-metal plates are especially advantageously spot-welded, as a result of which the sheet-metal plates can be joined nondetachably in an economical way, without additional fastening means. Also by spot welding, it is structurally simple to create a partial region that can be deflected perpendicular to the sheet-metal plate, specifically by not placing spot welds in this partial region.

### DRAWING

Additional advantages will become apparent from the ensuing drawing description. In the drawing, one exemplary embodiment of the invention is shown. The drawing, description and claims include numerous characteristics in combination. One skilled in the art will appropriately consider the characteristics individually as well and put them together to make useful further combinations.

Shown are:

FIG. 1, an electric scraper, having a scraper blade holder according to the invention, seen from the side;

FIG. 2, the scraper blade holder of FIG. 1, seen from below;

FIG. 3, a scraper blade;

FIG. 4, the scraper blade holder, seen from the side;

FIG. 5, the scraper blade holder, seen from above;

FIG. 6, a top plate of the scraper blade holder, seen from above;

FIG. 7, a section taken along the line VII-VII in FIG. 6;

FIG. 8, a middle plate of the scraper blade holder; and

FIG. 9, a bottom plate of the scraper blade holder.

### DESCRIPTION OF THE EXEMPLARY EMBODIMENT

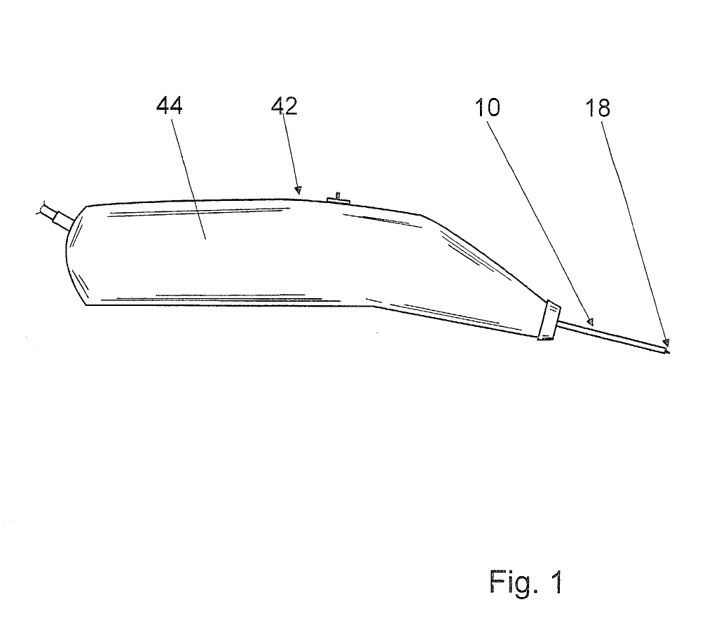

FIG. 1 shows an electric scraper 42, with an electric motor, not identified by reference numeral, in a housing 44; with this motor, via a gear, part of a holder can be moved back and forth with a translational motion. A scraper blade holder of the invention, having a scraper blade 18, is secured in the holder.

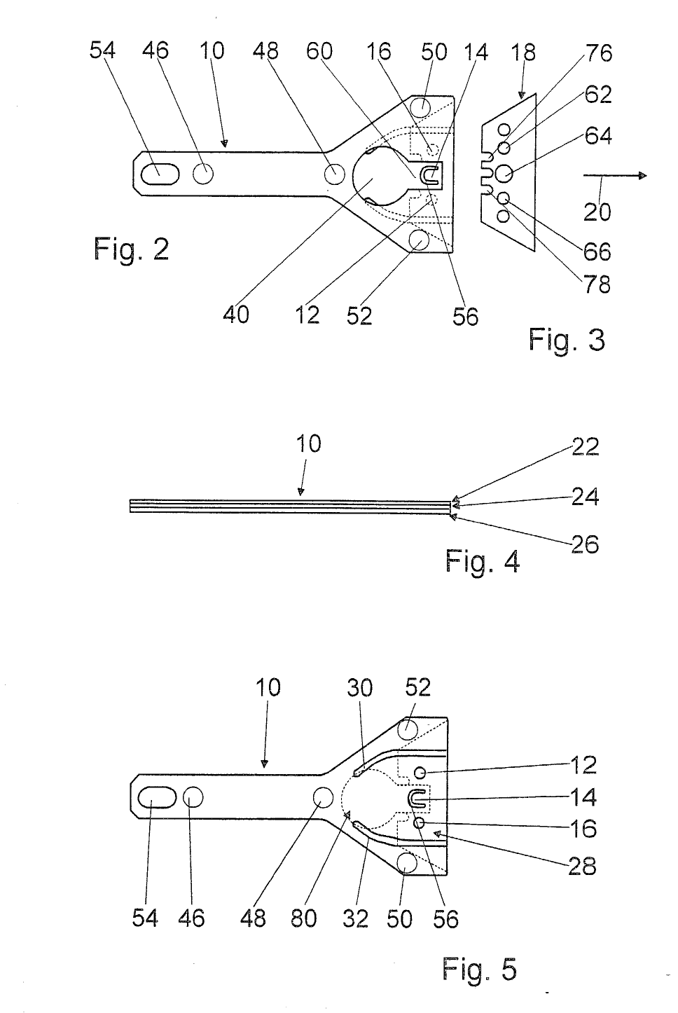

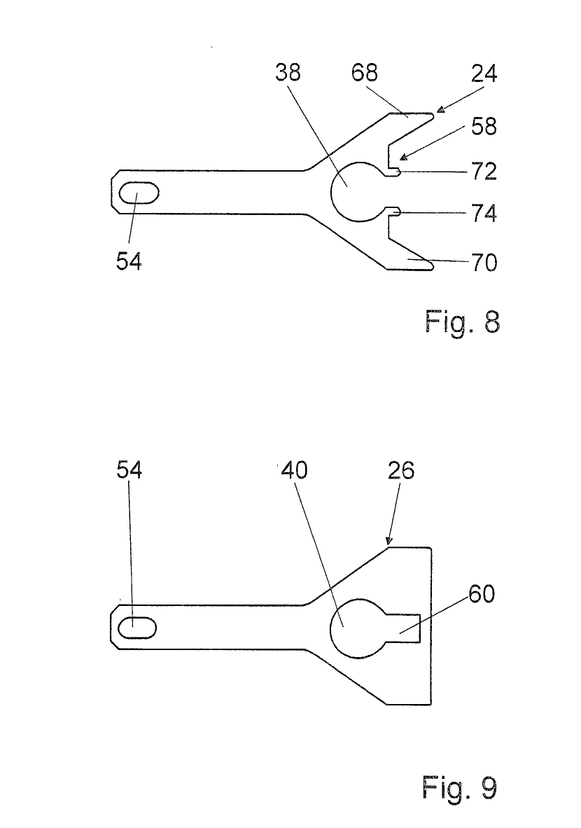

The scraper blade holder has a base body 10, which is constructed of three sheet-metal plates 22, 24, 26, specifically a top plate, middle plate and bottom plate (FIGS. 2-9), that extend in the machining direction 20 and are nondetachably joined via spot welds 46, 48, 50, 52. The sheet-metal plates 22, 24, 26 are cut out by a laser cutting process and are embodied as congruent in their outer contour, except for a face end oriented toward the scraper blade 18. The sheet-metal plates 22, 24, 26 form a narrow shaft, with an opening 54 for securing them to the holder of the electric scraper and with a retaining region for the scraper blade 18, which region extends in a V outward from the shaft toward the scraper blade 18. The opening 54 has a length greater than its width and has a rounded contour both in and counter to the machining direction 20, as a result of which an advantageous introduction of force from the electric scraper 42 to the tool holder can be achieved. On the face end pointing toward the scraper blade 18, the sheet-metal plate 24 or middle plate has a recess 58 for receiving the scraper blade 18 between the sheet-metal plates 22, 26, that is, the top plate and bottom plate (FIGS. 2, 3 and 8).

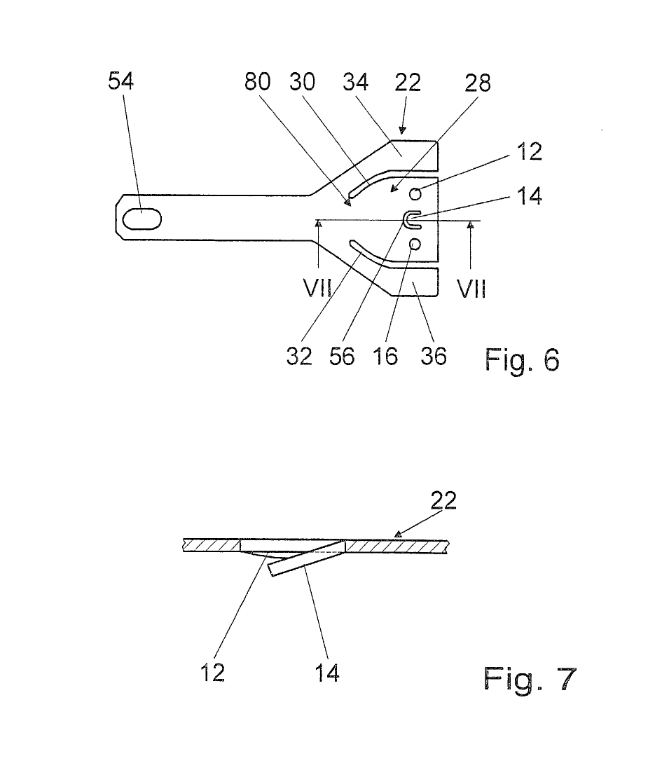

According to the invention, releasable fastening means 12, 14, 16 for securing the scraper blade 18 to a partial region 28 of the sheet-metal plate 22 or top plate are formed on and embodied as detent means; the aforementioned partial region is deflectable elastically by hand, without tools, perpendicular to the sheet-metal plate 22 in order to release the fastening means 12, 14, 16, specifically in the direction remote from the sheet-metal plate 26 or bottom plate. One fastening means 16 is disposed on a center axis of the base body 10 and is formed by a tab that points counter to the machining direction 20 and is exposed through a U-shaped recess 56; this tab is deflected in the direction of the sheet-metal plate 26 or bottom plate and extends through the recess 58 of the sheet-metal plate 24 or middle plate and through a square recess 60 in the sheet-metal plate 26 or bottom plate (FIGS. 6 and 7). The fastening means 12, 16 are disposed transversely to the machining direction 20, next to the fastening means 14, and are formed by round impressions made in the direction of the sheet-metal plate 26 or bottom plate, each forming a respective protuberance in the sheet-metal plate 22 or top plate pointing in the direction of the bottom plate.

The partial region 28 is exposed laterally by slitlike recesses 30, 32, which beginning at an end of the base body 10 oriented toward the scraper blade 18 extend longitudinally of the base body 10, while on their end remote from the scraper blade 18 they extend toward one another and between them form a spring region 80 (FIGS. 5 and 6). The partial region 28 is bounded laterally by cheeks 34, 36, which are solidly joined to the adjacent sheet-metal plate 24 or middle plate and to the sheet-metal plate 26 or bottom plate via the spot welds 50, 52.

If the scraper blade 18 is inserted counter to the machining direction 20 between the sheet-metal plates 22, 26, that is, between the bottom and top plates, into the recess 58 in the sheet-metal plate 24 or middle plate, the partial region 28 is elastically deflected by the fastening means 12, 14, 16 perpendicular to the sheet-metal plate 22 into the direction remote from the sheet-metal plate 26. If the fastening means 12, 14, 16 come to rest via corresponding openings 62, 64, 66 in the scraper blade 18, then the partial region 28 snaps back into its outset position, and the fastening means 12, 14, 16 lock in detent fashion in the openings 62, 64, 66 (FIGS. 2 and 3).

The scraper blade 18 is secured by positive engagement in the machining direction 20 by the fastening means 12, 16 and in particular by the fastening means 14 formed by the tab. Transversely to the machining direction 20, the scraper blade 18 is secured via side cheeks 68, 70 of the sheet-metal plate 24 or middle plate and by pegs 72, 74 on the sheet-metal plate 24 that point in the machining direction 20 and engage corresponding recesses 76, 78 in the scraper blade 18 (FIGS. 2, 3 and 8). The side cheeks 68, 70 of the sheet-metal plate 24 or middle plate have a counterpart contour to the scraper blade 18, transversely to the machining direction 20 of the scraper blade 18. Counter to the machining direction 20, the scraper blade 18 is braced on the face end of the sheet-metal plate 24 or middle plate. The cheeks 34, 36 of the sheet-metal plate 22 or top plate cover the scraper blade 18 from above in its lateral region. Forces perpendicular to the scraper blade 18 in the direction of the sheet-metal plate 22 can be withstood via the cheeks 34, 36, without the partial region 28 being deflected thereby and the fastening means 12, 14, 16 being released.

To release the fastening means 12, 14, 16 or to replace the scraper blade 18, a user, preferably with his thumb, can elastically deflect the partial region 28 around the spring region 809 through round, finger-sized recesses 40, 38 in the sheet-metal plate 26 and the sheet-metal plate 24, perpendicular to the sheet-metal plate 22 in the direction remote from the sheet-metal plate 26 and guide the fastening means 12, 14, 16 and detent means into a position that uncovers the scraper blade 18.

List of Reference Numerals

| | |
|---|---|
| 10 | Base body |
| 12 | Fastening means |
| 14 | Fastening means |
| 16 | Fastening means |
| 18 | Scraper blade |
| 20 | Machining direction |
| 22 | Sheet-metal plate |
| 24 | Sheet-metal plate |
| 26 | Sheet-metal plate |
| 28 | Partial region |
| 30 | Recess |
| 32 | Recess |
| 34 | Cheek |
| 36 | Cheek |
| 38 | Recess |
| 40 | Recess |
| 42 | Electric scraper |
| 44 | Housing |
| 46 | Spot weld |
| 48 | Spot weld |
| 50 | Spot weld |
| 52 | Spot weld |
| 54 | Opening |
| 56 | Recess |
| 58 | Recess |
| 60 | Recess |
| 62 | Opening |
| 64 | Opening |
| 66 | Opening |
| 68 | Side cheek |
| 70 | Side cheek |
| 72 | Peg |
| 74 | Peg |
| 76 | Recess |
| 78 | Recess |
| 80 | spring region |

1. A tool holder, having a base body (10) which is formed of at least one plate (22, 24, 26) and which has at least one releasable fastening means (12, 14, 16) for securing a tool (18), characterized in that the fastening means (12, 14, 16) is formed by a detent means, which is movable without tools out of its detent position into a position uncovering the tool (18).

2. The tool holder of claim 1, characterized in that the base body (10) is formed of a plurality of sheet-metal plates (22, 24, 26) extending in the machining direction (20).

3. The tool holder of claim 2, characterized in that the base body (10) is formed of three sheet-metal plates (22, 24, 26), that is, a top plate, middle plate, and bottom plate.

4. The tool holder of claim 3, characterized in that the tool (18) can be braced by positive engagement on the middle plate counter to the machining direction (20).

5. The tool holder of one of claims 2-4, characterized in that at least one fastening means (12, 14, 16) is disposed on a partial region (28) of a sheet-metal plate (22) which region can be deflected elastically by hand without tools perpendicular to the sheet-metal plate (22) in order to release the fastening means (12, 14, 16).

6. The tool holder of claim 5, characterized in that the partial region (28) is exposed laterally by means of recesses (30, 32) and is bounded laterally by cheeks (34, 36), which are solidly joined to an adjacent sheet-metal plate (24).

7. The tool holder of claim 5 or 6, characterized in that in at least sheet-metal plate (24, 26), a recess (38, 40) is made, by which the partial region (28) can be loaded for releasing the fastening means (12, 14, 16).

8. The tool holder of claim 7, characterized in that the recess (38, 40) is at least finger-sized.

9. The tool holder of one of claims 2-8, characterized in that at least one fastening means (12, 14, 16) is formed onto a sheet-metal plate (22).

10. The tool holder of claim 9, characterized in that at least fastening means (14) is formed by a tab pointing counter to the machining direction (20).

11. The tool holder of one of claims 2-10, characterized in that the sheet-metal plates (22, 24, 26) are spot-welded.

12. The tool holder of one of claims 2-11, characterized in that the sheet-metal plates (22, 24, 26) form a narrow shaft for securing in a machine tool (42), in particular in a hand-guided electric scraper.

13. The tool holder of claim 12, characterized in that a recess (58) for a translational, reciprocating drive is made in the shaft.

14. The tool holder of claim 13, characterized in that the recess (54) has a greater length than its width and has a rounded contour in and counter to the machining direction (20).

15. The tool holder of one of claims 2-11, characterized in that the sheet-metal plates form a handle.
